(19) United States
(12) Patent Application Publication
(10) Pub. No.: US 2004/0212112 A1
(43) Pub. Date: Oct. 28, 2004

(54) Method of producing film from polymer solution

(75) Inventor: Tadahiro Tsujimoto, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 10/830,402

(22) Filed: Apr. 23, 2004

(30) Foreign Application Priority Data
Apr. 25, 2003 (JP) 2003-122305

(51) Int. Cl. B29D 11/00; B29C 39/14; B29C 71/02

(52) U.S. Cl. 264/1.34; 264/216; 264/234; 264/101

(57) ABSTRACT

A dope containing cellulose acylate as a main content of polymer is cast on a moving belt in a method of producing a film. At least first and second drying units are arranged in a moving direction of the belt and disposed near the gel-like film on the belt. A temperature difference between a supplied drying air and an exhausted air in the first drying unit is higher than in the second drying unit. Further, the exhausted air of the first drying unit, in order to use as the drying air of the second drying unit, is heated by a heat exchanger such that the content of solvent is decreased. A produced film is excelling in thickness uniformity, and adequate to used as an optical polymer film. Polarizing filter, protective film, optical functioning film and liquid crystal display in which the film is used are excellent in optical properties.

### BACKGROUND OF THE INVENTION

1. Field of the Invention

The present invention relates to a method of producing a film from a polymer solution, and more particularly to a method of producing from a polymer solution an optical film with preferable optical properties, which is used as a protective film for a polarizing filter, in an optical functional film and in a liquid crystal display.

2. Description Related to the Prior Art

The liquid crystal display (hereinafter LCD) is constructed of a liquid crystal cell, a polarized element and an optical compensation sheet (birefringence sheet). In the transmittance type of the LCD, two polarized elements are provided in both sides of the liquid crystal cell, and one or two optical compensation sheet is disposed between the liquid crystal cell and the polarized element. In the reflection type of the LCD are superimposed a reflecting sheet, a liquid crystal cell, one optical compensation sheet, one polarized element in this order.

In the products for the optical use (such as these LCDs), it is necessary for the film constructing each layer of the product to have the thickness uniformly controlled with high accuracy and the uniformity of optical properties. For example, the thickness nonuniformity (or thickness-mura) in the protective film for a polarizing filter causes wrinkle which occurs when being attached to the polarizing element, a curled shape of the polarizing filter after attachment, and the like. Further, the optical film is coated with a hard coating layer for surface protection and an anti-reflection layer for preventing the reflection. The thickness nonuniformity often causes the nonuniform coating (or coating-mura). Especially, when the nonuniformity (or mura) cyclically occurs, the quality of images displayed by the LCD becomes extremely worse.

Conventionally, each Japanese Patent Laid-Open Publications No. 2001-129838, 2002-234042 teaches a film casting method as a method of producing a film which is provided with the best of the thickness uniformity and the optical properties. As the polymer used in the solution casting method, there are cellulose acylate, cyclo olefine and the like from which can be produced the film excellent in optical isotropy especially in a thickness direction of the film. In the solution casting method, polymers and several sorts of additives are added to a solvent to prepare for a polymer solution or a dispersion, which is cast on a continuously moving substrate to form a gel-like film. Then, the gel-like film is peeled and dried to obtain the film. Note that the polymer solution or the dispersion is usually called a dope or a dope solution.

However, recently, while the thinner thickness and the larger number of superposed films and the improvement of productivity are increasingly required, it is necessary to control the thickness of the film produced from the polymer with higher accuracy. Accordingly, the productivity is not enough improved and the thickness uniformity of the produced film is not controlled with high accuracy in the solution casting method. Further, when the optical properties, especially retardation values Re, Rth in birefringence are not uniform, the influence on the products is large. For example, the tinting and the inversion sometimes occur in the LCD, and when such an optical compensation sheet for enlarging view angle is used in the LCD, the change of the view angle and the color inversion sometimes occur.

### SUMMARY OF THE INVENTION

An object of the present invention is to provide a method of producing a film from a polymer solution, in which a cast dope is effectively dried without damage of a thickness and an optical properties of the film for optical use.

In order to achieve the object and the other object, in a method for producing a film from a polymer solution, a drying air is supplied to plural drying units which are arranged in a moving direction of the a substrate. The drying unit is closed to a gel-like film which is formed by casting the polymer solution on the substrate. The drying air blows toward so as to dry the gel-like film. The solvent evaporates from the gel-like film to generate a vapor. The drying unit exhausts an air containing a vapor. And a control is made such that a temperature difference between the supplied drying air and the exhausted air in a upstream drying unit of the plural drying units is larger than a in a downstream drying unit.

In preferable embodiment of a method of producing a film of the present invention, the film is dried with plural drying units arranged in a transporting direction of the film and disposed near the film. The each drying unit blows a drying air toward the film and aspirates an air containing a vapor to which the solvent is evaporated from the film, so as to exhaust the air as an exhausted air. The temperature difference between the drying air and the exhausted air in an upstream drying unit of the plural drying units is maintained larger than in a downstream drying unit.

According to a method of the present invention, the gel-like film formed by casting the polymer solution is effectively dried without damaging the thickness uniformity and optical properties of the produced optical polymer film. Further, the polarizing filter, protective film, optical functioning film and liquid crystal display in which the film is used are excellent in optical properties.

### BRIEF DESCRIPTION OF THE DRAWINGS

The above objects and advantages of the present invention will become easily understood by one of ordinary skill in the art when the following detailed description would be read in connection with the accompanying drawings.

FIG. 1 is a schematic diagram of a film production process to which a solution casting is applied as a method of producing a film of the present invention;

FIG. 2A is a schematic diagram of a casting equipment in a first embodiment of the present invention;

FIG. 2B is an explanatory view illustrating confronting areas of a gel-like film to drying units;

FIGS. 3 & 4 are explanatory views of angles between a blowing direction of a drying air and a gel-like film in the casting equipment;

FIG. 5 is a schematic diagram of an embodiment in which the present invention is applied to a tenter apparatus;

FIG. 6 is a schematic diagram of an embodiment in which the present invention is applied to a roller dying apparatus;

FIG. 7 is a schematic diagram of a casting equipment in a second embodiment of the present invention;

### PREFERRED EMBODIMENTS OF THE INVENTION

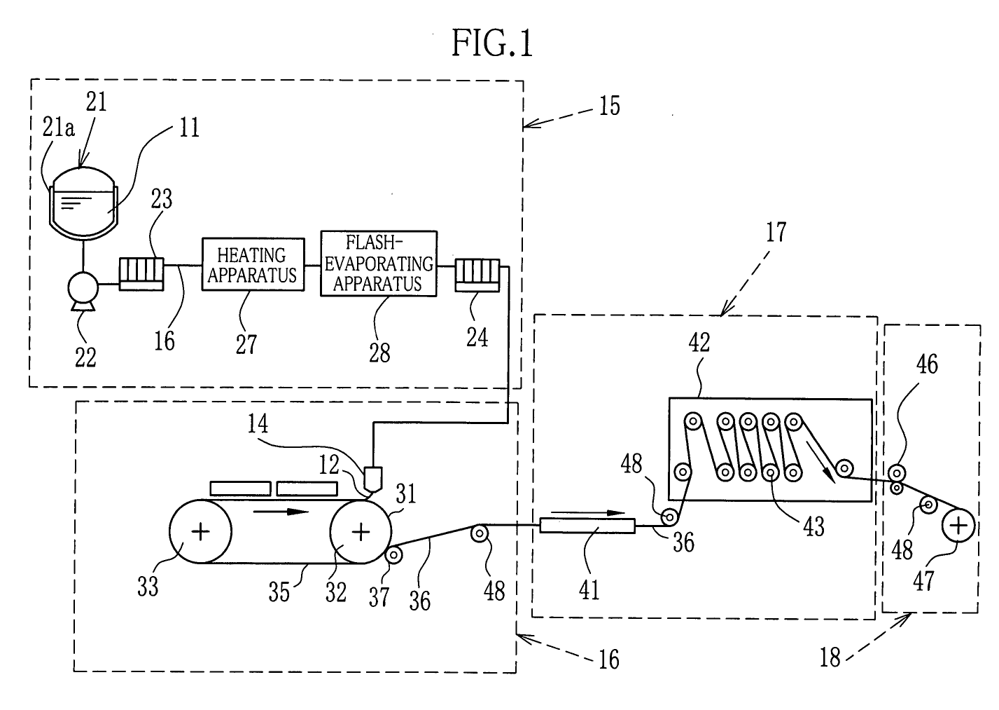

In a following explanation, a dope means a polymer solution including a solution and a dispersion liquid in which polymers and several sorts of additives are dissolved or dispersed. Further, in FIG. 1, a prepared dope 11 is a dope which is prepared in a dope preparation process which will be described in following, and a casting dope 12 is obtained by varying the prepared dope 11 so as to be have adequate characters for casting.

Film production facilities are constructed of a dope preparing equipment 15, a casting equipment 16, a drying equipment 17 and a winding equipment 18. The dope preparing equipment 15 is constructed of a tank 21 into which the prepared dope 11 is supplied, a pump 22, first and second filtering apparatuses 23, 24, a heating apparatus 27, and a flash-evaporating apparatus 28 for performing the flash-evaporation.

The tank 21 is provided with a thermostat 21a and a thermometer (not shown) so as to adequately heat and cool the prepared dope 11. In the present invention, it is preferable to heat once, and then cool the prepared dope 11 such that the solubility may increase. Further, in the heating and the cooling, the temperature is set in consideration with sort of the dope, particularly composition of a solvent of the dope. Especially, when a mixture solvent is used as the solvent, it is preferable that that the prepared dope 11 is heated and cooled in a multi-step manner to predetermined temperatures.

The prepared dope 11 is fed at a predetermined flow rate to the casting equipment 16 by the pump 22. The first and second filtering apparatuses 23, 24 are disposed between the pump 22 and the casting die 14 so as to remove remaining solid materials contained in the prepared dope 11. Further, after the filtration with the first filtering apparatus 23, the prepared dope 11 is heated by the heating apparatus 27 provided on a feed pipe, and the flash-evaporation is made in the flash-evaporating apparatus 28. Note that the heating apparatus 27 may be disposed in upstream from the first filtering apparatus 23.

The flash-evaporating apparatus 28 is used for changing the characters of the prepared dope 11 into that of the casting dope 12 which is adequate for the casting. In the flash-evaporating apparatus 28, the prepared dope 11 whose pressure is high is flashed into an air of the atmospheric pressure to perform the flash-evaporation. The solvent vapor generated by evaporating the prepared dope 11 is usually condensed and removed with use of a condenser (not shown) and discharged as a recovery solvent from the film production facilities.

After the flash-evaporation, the prepared dope 11 is fed out from the flash-evaporating apparatus 28, and it is preferable that remaining solid materials are removed by the second filtering apparatus 24 before feeding to the casting equipment 16. it is to be noted in the present invention that the apparatus for removing part of the solvent of the prepared dope 11 is not restricted in the above described flash-evaporating apparatus 28, and for example, a thin film evaporator with rotating scraper, a multiple-effect evaporator and the like, which are already known, may be used. Further, the inline static mixer (not shown) may be provided between the second filtering apparatus 24 and the casting equipment 16. In this case, the characters of the prepared dope 11 can be varied adequately.

Note in the present invention that a filter paper is used as a filter of the first filtering apparatus 23, and a sintered metal filter is used as a filter in the second filtering apparatus 24. Further, the present invention does not depend on the above dope preparing equipment 15.

The prepared dope 11 after the filtration is fed as the casting dope 12 to the casting equipment 16. The casting dope 12 fed to the casting equipment 16 is cast to form a gel-like film 35 on a belt 31 as a substrate moved on a loop path by a rotating apparatus (not shown). The belt 31 is supported by at least first and second drums 32, 33, whose rotation continuously moves the belt 31 on the loop path. A solvent gradually evaporates from the gel-like film 35 on the belt 31, such that the gel-like film 35 may have a self-supporting property. Then, the gel-like film 35 is peeled as a film 36 from the belt 31 by the peeling roller 37. A free roller or a drive roller may be used as the peeling roller 37. When the peeling roller 37 is the drive roller, it is preferable to drive the peeling roller 37 in regulation of at least one of a drawing ratio, a tension and a slack of the film 36. Note that the peeling roller 37 has two functions for both peeling and guiding the film 36 in the above embodiment. In the present invention, however, the peeling roller for peeling the film 36 and a guide roller for guiding the film 36 to the drying equipment 17 may be separately provided.

The drying equipment 17 is constructed of a tenter apparatus 41 and a roller drying apparatus 42. In the tenter apparatus 41, both side areas of the film 36 are held by grips (not shown) and so on to apply a tension to the film 36 for drying the film 36. Thereafter the film 36 is further dried in the roller drying apparatus 42 including many rollers. After the drying, the film 36 is cooled in a cooling apparatus (not shown) provided in downstream from the drying equipment 17, and thus the temperature of the film 36 lowers to the room temperature.

Preferably, the both side areas of the dried film 36 are cut off by a cutter 46 such that the film may have a width of a product. Thereafter, the film 36 is wound by a winding apparatus 47. In the present invention, rollers 48 may be provided between the above apparatuses and equipments, and the number of the rollers 48 is not restricted. Note that the present invention does not depend on the structure of the drying equipment 17, the winding equipment 18, and the methods of drying and winding. And the film may be dried and wound in several drying methods and winding methods which are already known.

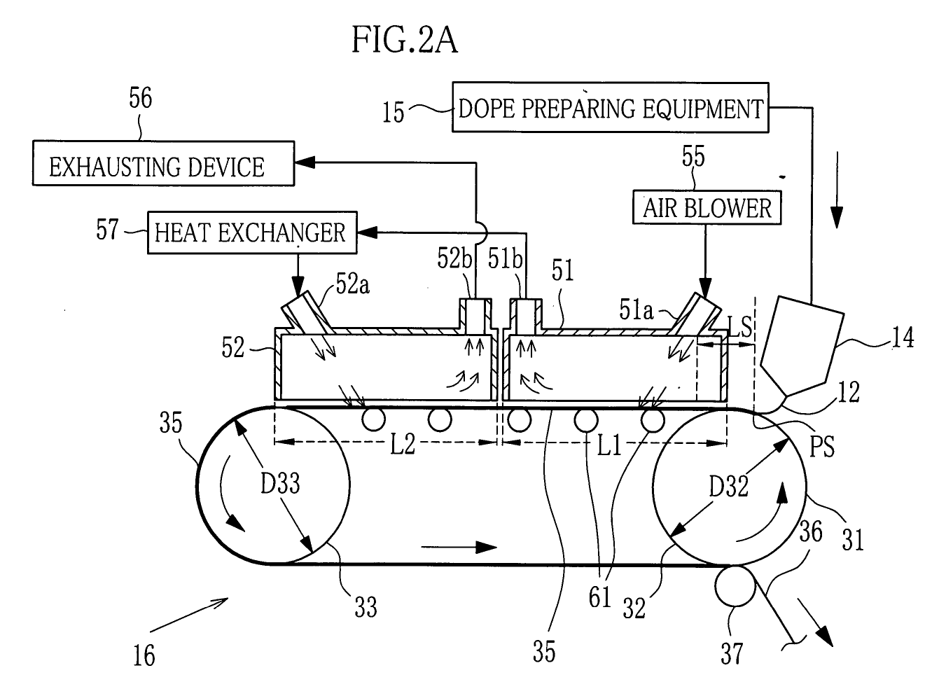

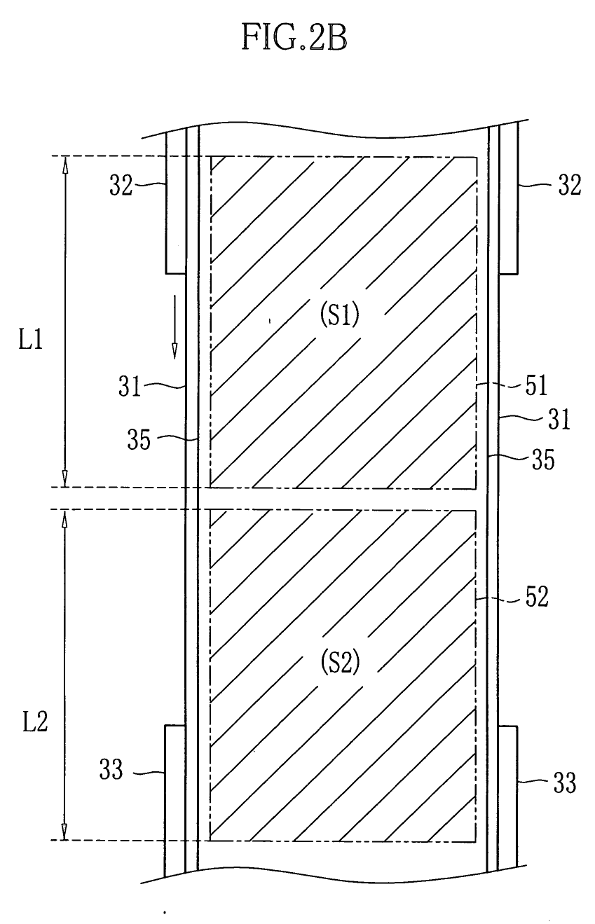

In reference to FIGS. 2A-2B, a casting process in the method of producing a film of the present invention will be explained. The casting equipment 16 includes the casting die 14, the first and second drums 32, 33, the belt 31, the peeling roller 37, first and second drying units 51, 52, an air blower 55, an exhausting device 56, a heat exchanger 57 as a temperature adjusting means. The first and second drying units 51, 52 are arranged in a transporting direction of the gel-like film 35 from upstream in this order. Further, there are plural path rollers 61 below upside part of the belt 31 between the first and second drums 32, 33, and the number of the path rollers 61 is adequately determined. However, the present invention is not restricted in the casting equipment 16. Note that in this embodiment, the number of the casting dope 12 cast on the belt 31 is one for forming the film having a single layer structure. However, the present invention may be applied to produce a film having a multi-layer structure (at least two layers).

The first and second drying units 51, 52 are disposed above the gel-like film 35. The first drying unit 51 is provided with an inlet port 51a an upstream side on a top and, and an exhaust port 51b in upside and a downstream side. An air is blown by the air blower 55 and supplied through the inlet port 51a into the first drying unit 51, and exhausted through the exhaust port 51b. The second drying unit 52 is provided with a inlet port 52a in upside and downstream side and a exhaust port 52b in upstream side on a top. A gas in the first drying unit 51 above the gel-like film 35 is exhausted through the exhaust port 51b from the first drying unit 51, and thereafter supplied through the inlet port 52a into the second drying unit 52. Then a gas in the second drying unit 52 above the gel-like film 35 is exhausted through the exhaust port 52b from the second drying unit 52. The exhausted air of the second drying unit 52 is fed to the exhausting device 56, in which the solvent is condensed and recovered to clean the exhausted air. In the first and second drying units 51, 52, the timing and the amount of the drying air and exhausting the exhausted air are separately adjusted. Note that the position of the first and second drying units 51, 52 is not restricted in this embodiment in which they are provided above the gel-like film 35. For example, a transporting path on which the belt 31 moves from the first drum 32 to the second drum 33 in upside is determined as a upper path, and that on which the belt 31 moves from the second drum 33 to the first drum 32 in downside is determined as a lower path. The first drying unit 51 may be disposed above the upper path, and the second drying unit 52 may be disposed below the lower path. Otherwise, the first and second drying units 51, 52 may be disposed below the lower path. Further, the first or second drying unit 51, 52 may be disposed so as to confront to the first or second drum 32, 33, in order to dry the gel-like film 35 on the first or second drum 32, 33.

Further, in the present invention, the number of the drying units is not restricted in two. It is preferable that the length of the belt 31 may be determined depending on a casting speed. When at least three drying unit is provided, the position of the drying units may be the same as when the two drying unit is provided, for example, above the upper path or below the lower path, or at the position so as to confront to the first or second drum 32, 33. Further, the blowing direction of the drying air in the first and second drying units 51, 52 may be the transport direction or the opposite direction thereto. In the opposite direction, the drying air is blown against the transport of the gel-like film. Anyway, it is preferable to provide the plural drying units for maintenance or improvement of a drying efficiency. When the number of the drying unit is one, the blowing length of the drying air is long. Therefore the temperature of the drying air becomes lower in the drying unit such that the drying efficiency becomes worse. In consideration thereof, the initial temperature or a flow rate of the drying air may be made higher. In this case, however, the foams are formed in the gel-like film 35, and the flat surface property becomes worse. These problems are prevented when the number of the drying units is at least two.

The inlet ports 51a, 52a and the exhaust ports 51b, 52b are extended in a widthwise direction of the gel-like film 35 such that the drying air may be blown on a surface of the gel-like film uniformly. One pair of the inlet port and the exhaust port is provide for each drying unit 51, 52 in this embodiment. However, in the present invention, the number of inlet and exhaust ports in each drying unit is not restricted. Further each inlet port may have different shape, and the number of the inlet ports may be different from that of the exhaust ports in one drying unit. Further, a bottom of each first and second drying units 51, 52 is open, and at least part of the drying air supplied into the drying units reaches the surface of the gel-like film 35.

The heat exchanger 57 has a function of a temperature adjusting means for adjusting the temperature of the exhausted air from the first drying unit 51 and as a solvent recovering means for recovering the solvent by removing the solvent vapor from the exhausted air. Further, the air blower 55 has a function for adjusting the flow rate and the temperature of the drying air to be supplied into the first drying unit 51.

In the present invention, it is preferable that a difference of temperatures between the drying air and the exhausted air is larger in the first drying unit 51 than that in the second drying unit. When the temperatures of the drying air and the exhausted air of the first drying unit 51 are represented as TS1 and TE1, and those of the drying air and the exhausted air of the second chamber 52 are represented as TS2 and TE2, the absolute value of TS1-TE1 is larger than the absolute value of TS2-TE2 in this embodiment. Further, the temperature TS2 of the drying air in the second drying unit 52 is preferably higher than the temperature TE1 of the exhausted air from the first drying unit 51. Accordingly it is preferable that the heat exchanger 57 heats the exhausted air from the first drying unit 51 to feed as the drying air to the second drying unit 52.

The transported gel-like film 35 is confronted to the respective first and second drying units 51, 52 at respective lengths L1, L2 in the moving direction of the belt 31. The surface of the gel-like film 35 confronts to a bottom of the respective first and second drying units 51, 52 with respective confronting areas S1, S2. And SA is the total value of S1 and S2. Note that as the bottom of each first and second drying unit 51, 52 is open, the area of open part of the bottom is almost the same as area of the bottom. Furthermore, V1 (m³/minute) is defined as a volume of the drying air supplied into the first drying unit 51 per one minute as unit time, and V2 (m³/minute) is defined as a volume of the drying air supplied into the second drying unit 52 per one minute as unit time. In the present invention, it is preferable that a condition 0.10<V1/S1<15 is satisfied in the first drying unit 51, and a condition 0.10<V2/S2<15 is satisfied in the second drying unit 52. And it is particularly preferable that the total value SA is from 20 m² to 200 m².

When at least three drying units are provided, the film confronting areas are S1, S2, S3, . . . , SN (N is optional natural number) sequentially from upstream to downstream, and the volumes of the drying air in the drying units are V1, V2, V3, . . . , VN (m³/minute; N is optional natural number) sequentially from upstream to downstream. It is preferable in the present invention, that a condition 0.10<VN/SN<15 is satisfied. Also in this case, it is preferable that the total value SA is from 20 m² to 200 m². When VN/SN is at least 15, the flow of the gas causes the nonuniform thickness and the nonuniform drying of the gel-like film 35. When VN/SN is at most 0.10, the drying speed becomes extremely lower, and thereafter it is not preferable. Further, when the total value SA is smaller than 20 m², the drying is not made enough. When the total value SA is larger than 200 m², the effect of enlarging the total value SA is often not so much.

In the above method, the solvent is evaporated from the gel-like film 35 in the first drying unit 51 and the gas therein contains the solvent vapor of high density. Accordingly, the exhausted air of the first drying unit 51 containing the solvent vapor so much is fed to the heat exchanger 57, in which the solvent can be recovered with high recovery yield. Further, when solvent evaporates more in the first drying unit than the second drying unit, the drying of the gel-like film is made efficiently, and the surface condition of the produced film 36 becomes better.

Further, when the exhausted air from the first drying unit 51 is supplied as the drying air to the second drying unit 52 after the decreasing of the content of the solvent vapor, it is prevented to increase flow rate of the drying air in the second drying unit. In order to decrease the content of the solvent vapor in the exhausted air from the first drying unit 51, the heat exchanger 57 cools the exhausted air to condense the solvent vapor to a recovery solvent. Thus the solvent components are removed from the exhausted air from the first drying unit 51. The temperature of the cooling is preferably in the range of −30° C. to 20° C. After the cooling, a remaining gas is heated to a predetermined temperature by the heat exchanger 57. Note that the solvent recovering device for recovering the solvent is not restricted the above heat exchanger. The solvent recovering device and the temperature adjusting device are separately provided to have their own independent functions.

In at least one of the first and second drying units 51, 52, the difference between the drying air and exhausted air, namely TS1-TE1, TS2-TE2 is in the range of 10° C. to 100° C. In the present invention, this condition of the temperature difference of the temperature is satisfied in both of the first and second drying units 51, 52. When the temperature difference is less than 10° C., the function that the gas in the drying unit is exhausted with containing the solvent vapor becomes low, and the evaporation of the solvent is not made so much. Further, when the temperature difference is larger than 100° C., the solvent vapor is condensed in the drying unit before the gas containing the solvent vapor is exhausted from the exhaust ports 51b, 52b. In this case, the condensed solvent is hardly fed out with exhausting the gas. Further, the temperature of the gel-like film 35 becomes higher, which causes the generation of foams in the gel-like film 35.

In at least one of the first and second drying units 51, 52, the temperature of the drying air is at least −30° C. and less than 10° C. In this embodiment, the temperature of the drying air supplied into the second drying unit 52 is in the above range. When the temperature of the drying air is too high, the solvent evaporates suddenly, and the surface condition becomes worse. As described above, the temperatures of the drying air and the exhausted air of the first and second drying units 51, 52 are determined in consideration with sorts of polymers and polymer-solvent compatibility. It is especially preferable to consider the boiling point and the solidifying point thereby.

Each first and second drying unit 51, 52 confronts through the gel-like film 35 to the belt 31 with respective belt confronting areas. In the present invention, at least one of the belt confronting areas is preferably in the range of 4 m² to 80 m². When both belt confronting areas are smaller than 4 m², the number of the inlet port and the exhaust port is made larger. In this case, however, the effect of enlarging the number of the inlet ports is not so large, and therefore there are demerits in view of cost. Further, when both confronting areas are larger than 80 m², the gas containing the solvent vapor remains in the drying unit, and the drying efficiency becomes lower. Further, the temperature of the drying air becomes lower, to make the drying efficiency lower.

It is preferable in the present invention that the belt 31 has a surface made of stainless, is 1 m to 3 m in width, and 25 m to loom in length. According to the surface condition thereof, an arithmetical averaged surface roughness Ra is preferably at most 0.1 μm. The surface condition of the belt directly influences on the easiness of peeling and the surface condition of the produced film. Accordingly, the arithmetical averaged surface roughness Ra is particularly preferably at most 0.05 μm.

Diameters D32, D33 of the respective drums 32, 33 supporting the belt 31 are preferably in the range of 1.5 m to 5m. The tension applied to move the belt 31 in the moving direction is in the range of 1.0×10⁵ N/m to 1.0×10⁶ N/m. When the tension is less than 1.0×10⁵ N/m, the belt 31 sags, and the good surface condition of the gel-like film 35 is hardly provided in drying the gel-like film 35 in the first and second drying units 51, 52. Further, when the tension is more than 1.0×10⁶ N/m, the friction occurs between the drum 32 and the belt 31, and the powder of the belt generated in the friction adheres to the gel-like film 35, which makes the quality of the produced film extremely lower.

The substrate of the present invention is not restricted in the belt 31. For example, when a drum is used as the substrate, it is preferable that the drum has a surface made of stainless, and an averaged surface roughness Ra is preferably at most 0.1 μm. Further, it is preferable the drum is 1 m to 3 m in width, and 5 m to 15 m in length of periphery. In this case, the tension applied to the gel-like film 35 is hardly controlled. Accordingly it is preferable to adequately adjust the casting speed in consideration the influence on the drying.

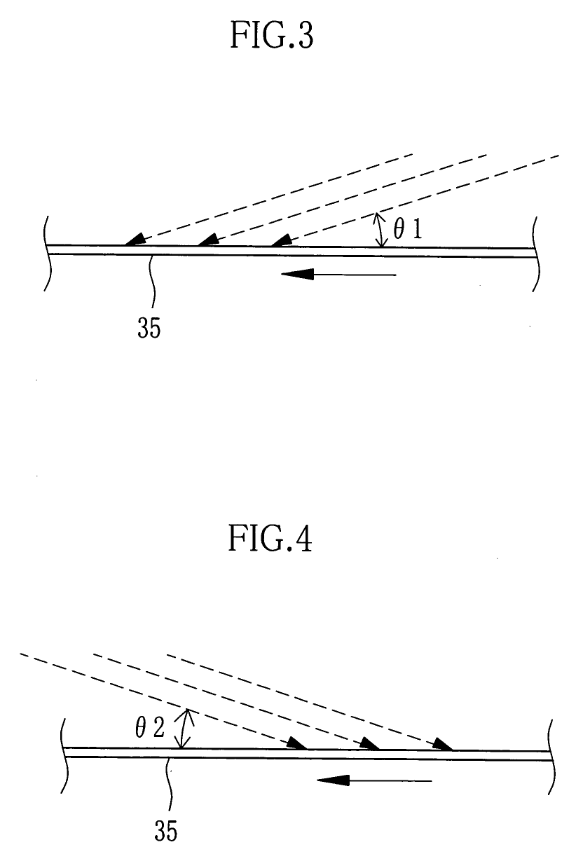

A casting position PS is defined as a position at which the polymer solution contacts to the belt 31 to form the gel-like film 35. A distance LS from the casting position PS to an upstream edge of the inlet port 51a of the first drying unit 51 is preferable at least 50 cm. Through the inlet port 51a, the drying air is blown with slanted toward the gel-like film 35. As shown in FIG. 3, a blowing direction of the drying air in the first drying unit 51 is illustrated with a dashed line which is inclined at an angle 01 to the moving direction of the belt 31. Preferably, the blowing direction is almost the same as the moving direction of the belt 31 (or the transporting direction of the gel-like film 35), and concretely the angle θ1 is at most 10°. In this case, the pressure applied to the surface of the gel-like film by the blown drying air does not make the smoothness worse.

In FIG. 4, a blowing direction of the drying air in the second drying unit 52 is illustrated with a dashed line which is inclined at an angle θ2 to an opposite direction of the moving direction of the belt 31. Preferably, the blowing direction is almost opposite to the moving direction of the belt 31 (or the transporting direction of the gel-like film 35), and concretely the angle θ2 is at most 10°. In this case, instable phenomena, such as the generation of foams in side area of the gel-like film 35, the defective peeling of the gel-like film 35 from the belt and the like are reduced.

The present invention does not depend on the thickness of the obtained film 36. However, the thickness of the gel-like film 35 just after the casting is preferably from 10 μm to 1000 μm, as the present invention is effective in this case. When the gel-like film 35 has the multi-layer structure, the thickness of the gel-like film 35 is defined as the total thickness of the layers formed in one casting process. The moving speed of the belt 31 is preferably from 5 m/minute to 200 m/minute. Note that the moving speed and the casting speed are the same.

In the present invention, a die of coat-hanger type is used as the casting die 14. This type is constructed of a die block and a feed block. Note that the present invention does not depend on the type of the casting die. For example, the casting die may be a multi-manifold type for performing the co-casting, or may be a combination of a die having the feed block and a die having a multi-manifold. Note that, in the present invention, a sequential casting may be made so as to form the film having the multi-layer structure.

In the above methods of the present invention, the obtained film 36 can have the uniform thickness, and the excellent optical polymer film can be obtained. The optical properties often depend on the variation of the film thickness. This tendency is especially large when the main content of the film 36 is polymers having a cyclic structure, such as aromatic polymers and others.

The present invention can be applied so far as polymers or precursors thereof are dissolved to the solvent to prepare the dope for producing the film. As the polymers or prepolymers, there are, for example, cellulose acylate, polycarbonate (PC), aramide resins, polyvinylalcohol, denatutrated polyvinylalcohol, polyacrylic acid esters, polymethacrylic acid esters, polyethylene telephthalate (PET), polybutylene telephthalate (PBT), chlorinated polyethers, polyacetal, polyether ether ketones (PEEK), polyether sulfone (PES), polyimide (PI), polyamides (PA), polyamide imide (PAI), polyphenyleneoxide (PPO), polyphenylene sulfone, poly sulfone, polyallylate, polyethylene (PE), polypropyrene (PP), polystylene (PS), polyvinyl chloride (PVC) and the like. One or combination of plurality of those may be used. It is preferably in the present invention, the polymer to be dissolved to the solvent contains the cellulose acylate.

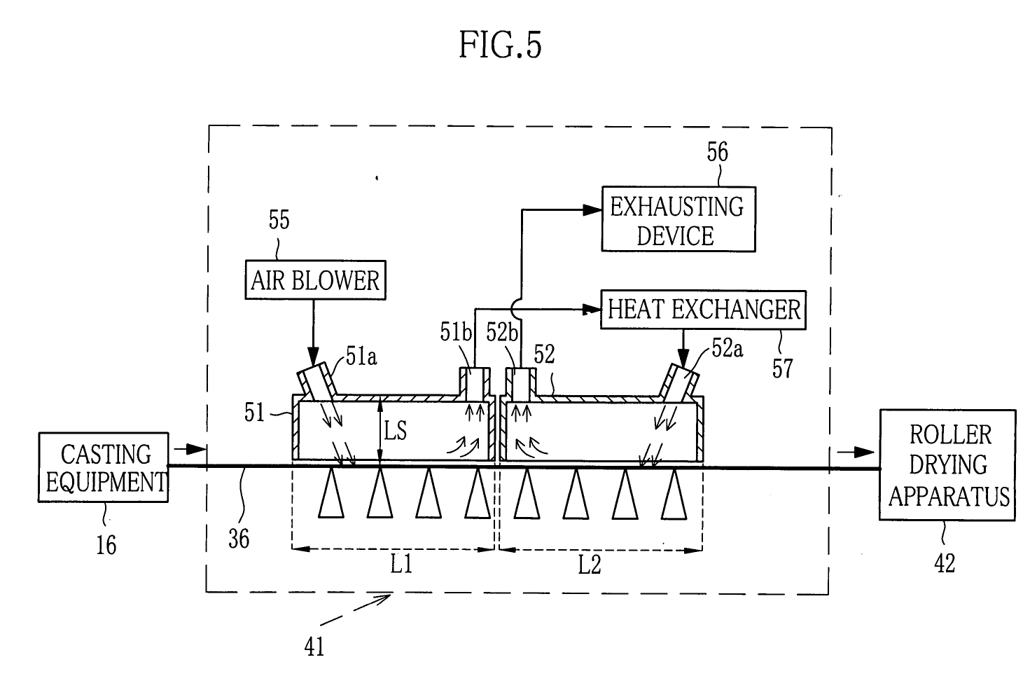

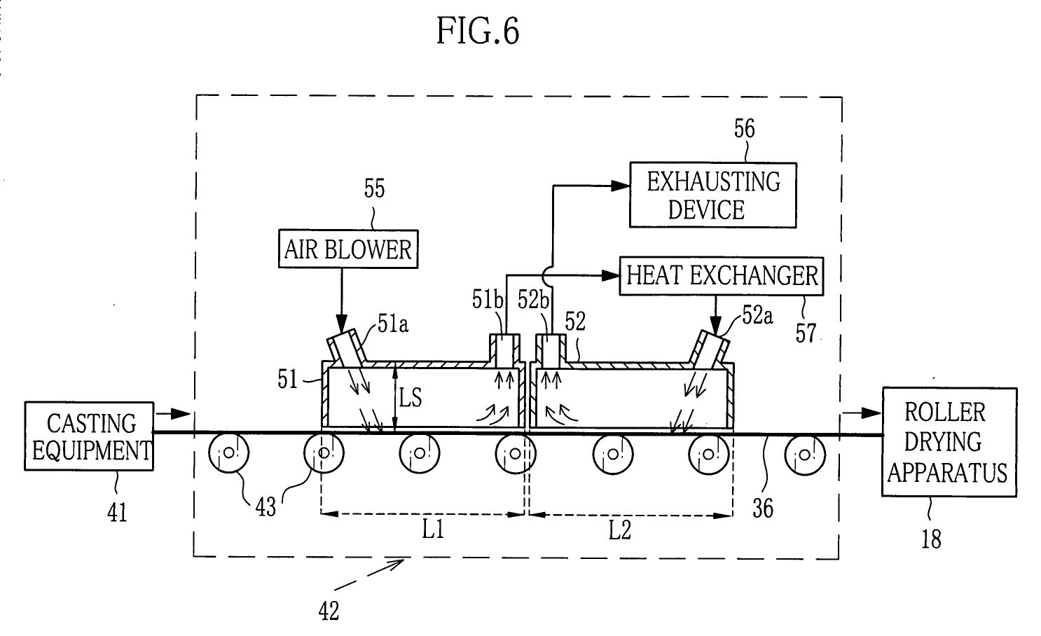

The present invention can be applied to the drying of not only the casting equipment 16 but also the tenter apparatus 41 and the roller drying apparatus 42. Such embodiments are illustrated in FIGS. 5 and 6, in which the same devices and members as in FIG. 2 are provided with the same number and the explanations therefor is omitted. In FIG. 5, the tenter apparatus 41, tenter clips or pins hold the side area of the film to transport the film toward the roller drying apparatus 42. The tenter apparatus 41 is constructed of the first and second drying unit 51, 52 disposed above the film 36, the heat exchanger 57 for recovering the solvent and adjusting the temperature of the exhausted air of the first drying unit, and the exhausting device 56 for processing the exhausted air of the second drying unit 52. The devices and the conditions thereof to be set may be the same as the casting equipment 16 explained in reference to FIG. 2.

As shown in FIG. 6, in the roller drying apparatus 42 a tension is applied to transport the film 36 with use of plural rollers 43. The roller drying apparatus 42 is constructed of the first and second drying unit 51, 52 disposed above the film 36, the heat exchanger 57 for recovering the solvent and adjusting the temperature of the exhausted air of the first drying unit 51, and the exhausting device 56 for processing the exhausted air of the second drying unit 52. The devices and the conditions thereof to be may be the same as the casting equipment 16 explained in reference to FIG. 2.

As described above, in the present invention, the plural drying units are provided with the tenter apparatus 41 and the roller drying apparatus 42 for drying the peeled film 36 having the self-supporting properties, and the temperature conditions are adequately set. Thus the drying is suitably made to stably perform the solution casting method as the method of producing the film and to obtain the film excellent in the smoothness.

The film obtained in the above method can be used as a protective film for polarizing filter. The polymer as a main content of a polarized film of the polarizing filter is especially preferable polyvinyl alcohol type polymer. As the polyvinylalcohol type polymers, there are not only polyvinyl alcohol, but also alkyl denatured polyvinylalcohol. Further, the polyvinylalcohol type polymers are usually produced by saponificating polyvinyl acetate to which vinylacetate is polymerized. However, the polyvinylalcohol type polymers may be produced in polymerization of vinyl acetate with small amount of the unsaturated carboxylic acid, their derivatives (for example, salts, esters, amides, nitrils and the like), olefins, vinyl ethers, salts of unsaturated sulfonic acids. Alkyl denatured polyvinylalcohols have alkyl group at an end of molecule thereof, and saponification degree is at least 80%, and polymerization degree is at least 200.

There are other polymers than polyvinyl alcohol type polymer, which can be used for the polarized film of the present invention, for example, polycarbonate type polymers, cellulose type polymer and the like.

When the polyvinylalcohol type polymers are used as the main content of the polarized film 12, the polarized film may be stained by a gas phase adsorption method or a liquid phase adsorption method. In this embodiment, the polarized film is stained by the liquid phase adsorption method. However, the present invention does not depend on these methods.

In the staining by the liquid phase adsorption method of this embodiment, iodine is used. However, the present invention is not restricted in it. The polyvinylalcohol film is dipped in the aqueous solution of iodine/potassium iodide (KI) for at least 30 seconds and at most 5000 seconds. Preferably, the concentration of iodine in the solution is from 0.1 g/L to 20 g/L, and that of potassium iodide is from 1 g/L to 100 g/L. Note that it is preferable that temperature of the solution for dipping the polyhvinyl alcohol is from 5° C. to 50° C.

In the liquid phase adsorption method, a solution of iodine or other dye may be coated or sprayed on the polyvinylalcohol film in a way already known, instead of the above method of dipping the polyvinylalcohol film. The polyvinylalcohol may be colored before or after stretching. However, after being stained, the polyvinylalcohol film adequately swells and the film thereof is tensed after staining. Accordingly, it is preferable that the polyvinylalcohol film is stained before stretching.

Instead of iodine, dichroic dye (including pigments) can be used. In the dichroic dyes, there are dye materials of azo dye, stilbene dye, pyrazolone dye, triphenylmethane dye, quinoline dye, oxadine dye, tiadine dye, anthraquinone dye and the like. Preferably, the dye materials can be dissolved to water. Preferably, dichroic dye has hydrophilic group, such as sulfonic acid group, amino group, hydroxyl group and the like.

As the dichroic dye, there are CI direct yellow 12, CI direct orange 39, CI direct orange 72, CI direct red 39, CI direct red 79, CI direct red 81, CI direct red 83, CI direct red 89, CI direct violet 48, CI direct blue 67, CI direct blue 90, CI direct green 59, CI acid red 37, and the like.

Further, there are other dyes described in Japanese Patent Laid-Open Publications No. 1-161202, 1-172906, 1-172907, 1-183602, 1-248105, 1-265205, 7-261024 and the like. these dichroic dyes are used as free acids, alkali metal salt, ammonium salt, and amine salt.

When the plural dichroic dyes are mixed, then the polarizer (or polarized film) can have several color phases or hues. Preferably, the polarizing filter (or the polarizing element) has compounds such that the two polarizing filters (or the polarizing elements) may show black when they are set in cross nicol position.

When it is designated that the polyvinylalcohol type film is tensed after coloring, then compounds (or cross-linking agent) for cross-linking polyvinylalcohol is used. Concretely, the polyvinylalcohol type film is dipped into a solution of the cross-linking agent, and otherwise the cross-linking agents are coated or sprayed onto the polyvinylalcohol type film. Thus, the polyvinylalcohol type film is hardened so as to have adequate orientation. Note that the cross-linking agent of polyvinylalcohol type polymer is described in the U.S. Reissued Pat. No. 232897 or may be others already known. Especially preferable are boric acid based materials.

In order to adhere the obtained film to the polarized film, there are a method of applying an adhesive agent, or a method of surface chemical treatment to supply an adhesive property for at least one of surfaces of the polarized film and the obtained film. When cellulose acylate is used as the polymer in the protective films, there are especially preferable methods for surface treatment, for example, acid treatment, alkali treatment, corona discharge treatment, glow discharge treatment, exposing to UV radiation.

In this embodiment, the film is adhered to the polarized film with the adhesive agent after the surface treatment. The surface treatment is saponification by alkali. Concretely, the film formed of cellulose acylate is dipped in alkali solution, and then neutralized in an acid solution, thereafter washed with a water, and dried. As the alkali solution, for example, sodium hydroxide and potassium hydroxide are used, and concentration thereof is preferably from 0.1N to 3.0N. Otherwise, the temperature of the alkali solution is preferably from the room temperature to 90° C.

The films are adhered to the polarized film with the adhesive agent, and the adhesive agent may be already known. Especially preferable are solutions of boron compounds or polyvinylalcohol which contain denatured polyvinylalcohol having acetoacetyl group, sulfonic acid group, carboxyl group, oxyalkylene group and the like. Preferably, the adhesive agent has thickness from 0.01 μm to 10 μm after drying, and particularly from 0.05 μm to 5 μm.

Further, the obtained film is used for an optical compensation film in which the film is coated with an antireflection layer, and for an optical functional film such as antireflection film in which an antiglare layer is formed on the obtained film. These products can be used as parts for a liquid crystal display.

In order to increase the effect of the present invention, the following embodiment is made other than the above described embodiment. Note that the present invention does not depend on the following embodiment.

[Preparation of Prepared Dope]

The method of preparing the prepared dope is usually to dissolve the polymer in a room temperature. In order to improve the uniformity of dissolving, a cool-dissolving method and a heat-dissolving method are adequately applied to the present invention.

In the cool-dissolving method, the polymer (cellulose acylate and the like), additives (particles and the like) are gradually added with stirring at nearly the room temperature from −10° C. to 40° C. The addition of the materials may be made simultaneously or sequentially. Note that solution or dispersion of each material may be prepared, and thereafter, the solutions or dispersions may be mixed. The cooling, for example, is made in a dried ice/methanol bath (−75° C.) or diethyleneglycol solution (−30° C. to −20° C.). Thus, the mixture of the solvent and the solid materials in the polymer solution is solidified. Thereafter, the mixture is heated to have temperature about 0° C. to 200° C., so as to obtain a solution in which the materials show fluidity in the solvent. In order to make the temperature larger, the mixture may be left in the room temperature or heated in a warm bath.

In the heat-dissolving method, the polymer (cellulose acylate and the like), additives (particles and the like) are gradually added in the solvent with stirring at nearly the room temperature from −10° C. to 40° C. The addition of the materials may be made simultaneously or sequentially. Then the solvent is heated to have the temperature about 70° C. to 240° C. under increasing pressure by about 0.2 MPa to 30 MPa. The preferable heating temperature is 80° C. to 220° C. Then the heated solution or dispersion is cooled to have the temperature which is lower than the lowest boiling point of the used solvent components. Usually, the solution or the dispersion is cooled at −10° C. to 50° C., to reduce the pressure to the atmospheric pressure. Preferably, cooled water is used as the cooling medium which is cooled by a cooling apparatus. Note that additives may be added if necessary.

It is preferable to make a filtration of the prepared dope obtained in the above method such that undissolved particles or the gel-like materials may be removed. As the filter medium used in the filtration, there are a filter paper, a filter cloth, a metallic mesh, a metallic fiber, non-woven cloth and the like. Further, when the criterion of the dope against the remaining of the foreign particles or the undissolved particles is strict, plural filtration apparatuses are disposed serially, and they are sequentially or respectively offline, such that the uniformity of the dope may be improved by multi-filtration.

Further, in a system in which particles are added to the prepared dope, it is preferable to make the filtration of the prepared dope containing the particles. Some sorts of particles agglutinate in effect of compatibilities to the particles oneself or to the prepared dope. Thus the agglutinated particle has the larger diameter, which is usually preferably removed. Such particles, there are silica (SiO₂) particles added as a matting agent.

[Solvent]

The solvent used in the present invention is hydrocarbon halides, esters, ketones, ethers, alcohols and the like. However, it is not restricted in them. The single sort of the solvent may be used (100 wt. %) as the solvent of the dope, and otherwise the several sorts of the solvents may be mixed at a predetermined mixture ratio.

As the usable solvent, there are hydrocarbon halide (for example, dichloromethane, chloroform and the like), esters (methyl acetate, methyl formate, ethyl acetate, amyl acetate, butyl acetate and the like), ketones (for example acetone, methylethylketone, cyclopentanone, cyclohexanone and the like), ethers (for example dioxane, dioxolane, tetrahydrofuran, diethyl ether, methyl-t-butyl ether and the like), alcohols (for example methanol, ethanol, isopropyl alcohol, n-propyl alcohol, n-butanol, cyclohexanol, cyclopentanol and the like), aromatic hydrocarbon (for example benzene, toluene, xylene, hexane and the like), and the like.

It is effective in the present invention that methyl acetate is used as a single solvent or as a main content of the mixture solvent. When the mixture solvent is used, the characteristics of the dope (such as the gel strength and the shear viscosity, and the like) can be easily adjusted. As the solvent of subcontents which are mixed with the methyl acetate, there are not only ketones but also alcohols (methanol, n-butanol and the like). Further, the mixture solvent may be prepared by mixing methyl acetate and at least two sorts of the solvents. Note that the main content of the mixture solvent means the solvent having the largest content ratio of the mixture solvent, and the subcontents mean the solvents which has not the largest content ratio of the mixture solvent. Further, the subcontents are not restricted in one sort of solvents.

When cellulose triacetate (TAC) is used as the polymer and methyl acetate is used as the main content of the solvent to prepare the dope, it is preferably in view of dissolubility of TAC that the content percentage of methyl acetate in the mixture solvent is 50 wt. % to 93 wt. %, that of ketones is 2 wt. % to 20 wt. % (for example acetone, methylethylketone, cyclopentanone, cyclohexanone and the like, and one of them may be used or plurality of them may be used), and that of alcohols is 5 wt. % to 30 wt. % (for example methanol, ethanol, isopropyl alcohol, n-propylalcohol, n-butanol, cyclohexanol, cyclopentanol and the like, and one of them may be used or plurality of them may be used). Further, ketones and alcohols may be mixed with at least 93 wt. % methyl acetate to obtain the mixture solvent.

When it is designated to use cellulose triacetate (TAC) as the polymer, dichloromethane can be used as a single solvent or as a main content of the mixture solvent. As TAC easily dissolves the dichloromethane, the preparation of the polymer solution is made easily. Further, the same as methyl acetate is used, when dichloromethane is used as the main content of the mixture solvent, the characteristics of the polymer solution are adjustable. Preferably, the content ratio of dichloromethane in the mixture solvent is 50 wt. % to 95 wt. %, that of ketones is 0 wt. % to 20 wt. % (for example acetone, methylethylketone, cycropentanone, cycrohexanone and the like, and one of them may be used or plurality of them may be used), and that of alcohols is 5 wt. % to 30 wt. % (for example methanol, ethanol, isopropyl alcohol, n-propyl alcohol, n-butanol, cyclohexanol, cyclopentanol and the like, and one of them may be used or plurality of them may be used). Otherwise, ketones and alcohols may be mixed with at least 95 wt. % dichloromethane to obtain the mixture solvent.

[Additives]

Additives used in the present invention is not especially restricted. As the additives, there are plasticizers, UV-absorbing agent, matting agents, mold lubricant, fluoride type surface active agent, release agent, deterioration inhibitor, retardation adjuster, gelating agent, and the like. The additives may be mixed with the polymers in any step of preparing the dope solution, and otherwise, may be added to the casting dope just before the casting is made. For example, the additives may be added when the polymer is swollen, and otherwise, may be added to the casting dope and mixed by a static mixer when or just before the casting solution is cast from a casting die onto the substrate in a film production process.

[Plasticizer]

As the plasticizer used in the present invention, there are phosphoric acid ester types (for example triphenylphosphate (TPP), tricresyl phosphate, cresyldiphenyl phosphate, octyldiphenylphosphate, biphenyldiphenyl phosphate (BDP), trioctylphosphate, tributylphosphate and the like), phthalic acid ester types (for example diethylphthalate, dimethoxyethylphthalate, dimethylphthate, dioctylphthalate and the like), grycolic acid ester types (for example triacetine, tributyline, butylphthalylbutylgrycolate, ethylphthalylethylgrycolate, methylphthalylethylgrycolate, butylphthalylbutylgrycolate and the like) and other plasticizers.

Only one of the plasticizer may be used, and otherwise plural plasticizers may be mixed. The plasticizers are preferably contained 1-20 wt. % to the polymer in the dope solution. Further, other plasticizers described in Japanese Patent Laid-Open Publication No. 11-80381, 11-124445, 11-248940 may be also used.

[UV-Absorbing Agent]

In the present invention, preferably, one or more UV-absorbing agent is preferable to be contained in the solution. In view of the protection of the deterioration of liquid crystal compounds, the UV-absorbing agent is preferably excellent in absorbing UV-ray whose wave length is equal or less than 370 nm. Further, in view of the displayability of the liquid crystal, the UV-absorbing agent preferably does not absorb visible ray whose wave length is equal or more than 400 nm.

As the UV-absorbing agent, there are, for example, oxybenzophenone type compounds, benzotriasol type compounds, salicylic acid ester type compounds, benzophenone type compounds, cyanoacrylate type compounds, nickel complex salt type compounds. Particularly preferable are benzotriasol type compounds and benzophenone type compounds. Especially preferable are benzotriazol type compounds, as they don't unexpectedly carry out the coloring of the cellulose ester. Furtherthere are UV-absorbing agent of benzotriasol type compounds disclosed in Japanese Patent-Laid Open Publication No. H08-29619 and UV-absorbing agent disclosed in Japanese Patent Laid-Open Publication No. H08-239509. Furthermore, other UV-absorbing agents already known can be added. The content of UV-absorbing agents is preferably contained in 0.1-10 wt. % to the polymer.

As the preferable UV-absorbing agent, there are, 2,6-di-tert-butyl-p-crezol, pentaerythrytyl-tetrakis[3-(3,5-di-tert-butyl-4-hydroxyphenyl)propionate], triethyleneglycol-bis[3-(3-tert-butyl-5-methyl-4-hydroxyphenyl)propionate], 1,6-hexanediol-bis[3-(3,5-di-tert-butyl-4-hydroxyphenyl)propionate], 2,4-bis-(n-octylthio)-6-(4-hydroxy-3,5-di-tert-butylanilino)-1,3,5-triazine, 2,2-thio-diethylenebis[3-(3,5-di-tert-butyl-4-hydroxyphenyl)propionate], 2(2′-hydroxy-3′,5′-di-tert-butylphenyl)-5-chlorobenzotriazol, 2(2′-hydroxy-3′,5′-di-tert-amylphenyl)-5-chlorobenzotriazol, octadecyl-3-(3,5-di-tert-butyl-4-hydroxyphenyl)propionate, N,N′-hexamethylenebis(3,5-di-tert-butyl-4-hydroxy-hydrocynenamide), 1,3,5-trimethyl-2,4,6-tris(3,5-di-tert-butyl-4-hydrozybenzil)benzene, tris(3,5-di-tert-butyl-4-hydroxybenzil)-isocianulate, and the like. Especially preferable are 2,6-di-tert-butyl-p-crezol, pentaerythrytyl-tetrakis[3-(3,5-di-tert-butyl-4-hydroxyphenyl)propionate], triethyleneglycol-bis[3-(3-tert-butyl-5-methyl-4-hydroxyphenyl)propionate]. Further, metal deactivators of hydradine compounds (such as N,N′-bis[3-(3,5-di-tert-butyl-4-hydroxyphenyl)propionyl]hydradine and the like), and phosphate processing stabilizer (such as tris(2,4-di-tert-butylphenyl)phosphate and the like) may be mixed and used.

[Matting Agent]

The dope solution preferably contains matting agent (particle powders) for improving an adhering endurance property under high moisture and a slipping property of the film. An averaged height of umbones of the matting agent on a surface is preferably 0.005-10 μm, particularly 0.01-5 μm. The number of the umbones is preferably large. However, when it is larger than necessary, the umbones cause the haze. Further, the primary diameter of the particle is preferably 1 nm to 500 nm. However, the present invention is not restricted in the description. The matting agent may be inorganic and organic compounds. As inorganic matting agents, there are inorganic particles, such as barium sulfate, manganese colloid, titanium dioxide, strontium sulfate, silicon oxide type (silicon dioxide and the like), aluminum oxide, zinc oxide, tin oxide, calcium carbonate, barium sulfate, talc, caoline, calcium sulfate. Further, there are silicone dioxide, (for example synthetic silica obtained in wet processing or by gelating silicic acid) and titanium dioxide (rutile type, anatase type) produced from titanslag and sulfuric acid.

The inorganic matting agent may be obtained also by milling inorganic compound whose diameter is more than 20 μM. In this case, after the milling, the classification of inorganic compound is carried out for example by vibrating filtration, wind power classification.

As the organic compound, there are organic polymer compounds which is milled and classified, for example, polytetrafluoroethylene, cellulose acetate, polystyrene, polymethyl methacrylate, polypropyl methacrylate, polymethyl acrylate, polyethylene carbonate, acrylstyrene type resins, silicone type resins, polycarbonate type resins, benzoguanamine type resins, melamine type resins, polyolefin type powders, polyester type resins, polyamide type resins, polyimide type resins, polyfluoroethylene type resins and starch. There are further polymer synthesized in suspension polymerization, polymers having ball shape that are obtained in spray drying method or dispersing method, and inorganic compounds. However, when the amount of the particle powders is too large in the dope solution, the flexibility of the film becomes lower. Accordingly, the dope solution preferably contains the particle powders in 0.01-5 wt. % to the polymer.

[Mold Lubricant]

Mold lubricants are often added to the dope in order to make the molding more easily. In the mold lubricants there are waxes having high boiling points, higher fatty acid and salt form thereof, esters, silicone oil, polyvinyl alcohol, low molecular weight polyethylene, derivatives of vegetable proteins and the like. However, the present invention is not restricted in them. It is preferable to adjust the quantity of mold lubricant to be added such that the weight percentage of the mold lubricant to the polymers in the dope may be in the range of 0.001 wt. % to 1 wt. %, since the mold lubricants have influences on the brilliance and smoothness of the film.

In the dope, fluoride surface-active agents may be also added. The fluoride surface-active agents have a hydrophobic group of fluorocarbon chain, and therefore is used as casting agent in organic solvent or a antistatic agent while it decreases a surface tension. As the fluoride surface-active agent there are, for example, C₈F₁₇CH₂CH₂O—(CH₂CH₂O)₁₀—OSO₃Na, C₈F₁₇SO₂N(C₃H₇)(CH₂CH₂O)₁₆—H, C₈F₁₇SO₂N(C₃H₇)CH₂COOK, C₇F₁₅COONH₄, C₈F₁₇SO₂N(C₃H₇)(CH₂CH₂O)₄—(CH₂)₄—SO₃Na, C₈F₁₇SO₂N(C₃H₇)(CH₂)₃—N⁺(CH₃)₃⁻, C₈F₁₇SO₂N(C₃H₇)CH₂CH₂CH₂N⁺(CH₃)₂—CH₂COO⁻, C₈F₁₇CH₂CH₂O(CH₂CH₂O)₁₆—H, C₈F₁₇CH₂CH₂O(CH₂)₃—N⁺(CH₃)₃.I⁻, H(CF₂)₈—CH₂CH₂OCOCH₂CH(SO₃)COOCH₂CH₂CH₂CH₂—(CF₂)₈—H, H(CF₂)₆CH₂CH₂O(CH₂CH₂O)₁₆—H, H(CF₂)₈CH₂CH₂O(CH₂)₃—N⁺(CH₃)₃.I⁻, H(CF₂)₈CH₂CH₂OCOCH₂CH(SO₃)COOCH₂CH₂CH₂CH₂C₈F₁₇, C₉F₁₇—C₆H₄—SO₂N(C₃H₇)(CH₂CH₂O)₁₆—H, C₉F₁₇—C₆H₄—CSO₂N(C₃H₇)—(CH₂)₃—N⁺(CH₃)₃.I⁻.

The amount of the fluoride surface active agent in the dope solution is preferably 0.001-1 wt. % to the polymer.

[Release Agent]

The release agents may be added to the dope so as to decrease the peeling force. As the release agent, surface-active agents are especially preferable. There are phosphoric acid type, sulfonic acid type, carboxylic acid type, nonionic type, cationic type and the like in the release agent. However the release agents are not restricted in them. These releasing agents are described in Japanese Patent Laid-Open Publication No. 61-243837. Further, Japanese Paten Laid-Open Publication No. 57-500833 teaches polyethoxylic phosphoric acid ester as release agent. In the Japanese Paten Laid-Open Publication No. 61-69845, the peeling is smoothly made by adding to cellulose ester mono/diphosphoric acid alkylester in which non-esterified hydroxylic group has a free acid form. Further, in Japanese Patent Laid-Open Publication No. 1-299847, a peeling force is decreased by adding inorganic particles and phosphoric acid ester compounds having non-esterified hydroxylic group and propyreneoxide chain. These materials can be used as the release agent. The amount of the release agent is 0.001-1 wt. % to the polymers.

[Deterioration Inhibitor]

Further, deterioration inhibitors (antioxidant, peroxide decomposer, radical inhibitor, metal deactivator, acid capture, amine and the like) and UV-stabilizer may be added to the dope. Such deterioration inhibitors and UV-stabilizers are disclosed in Japanese Patent Laid-Open Publication No. 60-235852, 3-199201, 5-1907073, 5-194789, 5-271471, 6-107854, 6-118233, 6-148430, 7-11056, 7-11055, 7-11056, 8-29619, 8-239509 and 2000-204173. The especially preferable deterioration inhibitor is butylized hydroxyl toluene (BHT). Further, it is preferable to prepare the polymer solution which contains 0.01 wt. % to 5 wt. % deterioration inhibitor to the polymer.

(Retardation Adjuster)

In the present invention, retardation adjuster may be added to the dope for controlling the optical anisotropy. Aromatic compounds having at least two aromatic groups are preferably used as the retardation adjuster. Further, at least two sorts of aromatic compounds may be simultaneously used. In the aromatic group of the aromatic compounds, there are not only the aromatic hydrocarbon group, but also heterocyclic group having character of aromatic hydrocarbon. Note that it is preferable to prepare the polymer solution which contains 0.01 wt. % to 10 wt. % retardation adjuster to the polymer.

The aromatic hydrocarbon group is especially preferably 6-membered ring (benzene ring). The aromatic hetero ring is usually unsaturated hetero ring, and preferably 5-membered ring, 6-membered ring, or 7-membered ring, and especially preferably 5-membered ring, or 6-membered ring. Usually, double bonds in the heterocyclic group having character of aromatic hydrocarbon is formed at the largest number (or the maximal number). As hetero atoms used in the present invention, nitrogen atom, oxygen atom, and sulfer atom are preferable, and nitrogen atom is especially preferable. As the heterocyclic group having character of aromatic hydrocarbon, there are furan ring, thiophene ring, pyrrol ring, oxazol ring, thiazol ring, isothiazol ring, imidazol ring, pyrazol ring, furazan ring, triazol ring, pyran ring, pyridine ring, pyridazine ring, pyrimidine ring, pyradine ring, and 1,3,5-triadine ring and the like.

(Method of Measuring Concentration of Solid Material in Dope)

In the method of measuring the concentration of the solid material in the dope, the weight of the predetermined volume of the dope is sampled from the film production line. The sampled dope is dried for two hours at 120° C., and the weight of remaining materials is measured. The concentration of the solid material is calculated as the weight percentage from the ratio of the weight of the remaining solid material to the sampled dope. Note that in the present invention, the solid material means the mixture of the polymer and the additives which are raw materials of the film. When they are pure material in the room temperature, they are not always solid. Accordingly, the present invention does not depend on the method of measuring the concentration of the solid material.

### EXPERIMENT

The experiment of the present invention is made as follows. However, the present invention is not restricted in the experiment.

### Example 1

A dope A is prepared to have the following content. Note that the raw materials of cellulose triacetate is wood pulp, and the UV-absorbing agents I, II, III are respectively 2-(2′-hydroxy-5′-methylphenyl)benzotriazol, 2,2′-hydroxy-4-methoxybenzophenon, and 2(2′-hydroxy-3′,5′-di-tert-butylphenyl)-5-chlorobenzotriazol.

| | |
|---|---|
| Cellulose triacetate | 18.90 pts. wt. |
| (degree of acetylation, 60.7%, degree of polymerization | |
| 315, degree of substitution for acetyl group at 6 position | |
| 0.94, averaged diameter of particle 0.5 mm) | |
| Triphenylphosphate (TPP) | 1.00 pts. wt. |
| Biphenyldiphenylphosphate (BDP) | 0.60 pts. wt. |
| Diethylphthalate | 0.50 pts. wt. |
| UV-absorbing agent I | 0.10 pts. wt. |
| UV-absorbing agent II | 0.20 pts. wt. |
| UV-absorbing agent III | 0.30 pts. wt. |
| particles of silicon dioxide | 0.05 pts. wt. |
| (particle diameter 15 nm, mohs hardness about 7) | |
| partial ester form of ethyl citrate | 0.02 pts. wt. |
| tribenzylamine | 0.30 pts. wt. |
| methylene chloride | 60.90 pts. wt. |
| methanol | 15.60 pts. wt. |
| ethanol | 1.20 pts. wt. |
| n-butanol | 0.40 pts. wt. |

The method of preparing the dope A is as follows. At first, a mixed solvent of the methylene chloride, methanol, ethanol and n-butanol is cooled to 0° C., and to the mixture solvent are added solid materials with stirring to make the uniform dispersion. Thereafter, the pressure to the dispersion is increased to 20 kg/cm², and simultaneously the dispersion is heated to two preset temperatures with a pipe including static mixers. Thus the solid materials are dissolved to obtain a dope. The preset temperatures are at first 70° C. and thereafter 38° C. Further, the dope is sequentially cooled to two preset temperatures, and thereafter the filtration is made with use of a filter paper whose absolute pore diameter is 10 μm. The present temperatures of the cooling is at first 70° C. and thereafter 38° C. The filtrated solution is heated to make the flash-evaporation. Thus part of solvent is evaporated, and the density of the solid content is made to 23%. Thereafter, the filtration is made with use of a sintered metal filter whose absolute pore diameter is 5 μm, so as to obtain the dope A.

(Film Producing Method)

The casting is made with use of the casting equipment 16 as illustrated in FIG. 2A. The substrate is the belt 31 whose surface is made of stainless. The surface treatment is made such that the arithmetical averaged surface roughness Ra may be 0.03 μm. Note that the belt 31 is tensed at 2.0×10⁵ N/m in the transporting direction of the gel-like film 35. The diameter of the drum for supporting the belt 31 is 2.2 m.

The dope A is applied to the belt 31 to be 1560 mm in width, such that the thickness of the film to be produced may be 38 μm. The casting speed is 30 m/minute. Above the gel-like film are disposed the first drying unit 51 and the second drying unit 52. In the first drying unit 51, the temperature of the drying air is 110° C., and that of the exhausted air is 45° C. Note that the upstream end of the first drying unit 51 in the transporting direction is positioned 2.5 m downstream from a casting position PS at which the cast dope A contacts to the belt 31. Further, in the second drying unit 52, the temperature of the drying air is 80° C., and that of the exhausted air is 40° C.

Further, in the first drying unit 51, the drying air is blown at an angle 0° to the transporting direction of the belt 31, and in the second drying unit 52, the drying air is blown at an angle 5° to the opposite direction to the transporting direction. Furthermore, both of the ratio V1/S1, V2/S2 of the volumes of the drying airs to the confronting areas of the surfaces confronting to the first and second drying units 51, 52 are 6.0. Both confronting areas of the gel-like film 35 on the belt 31 in the first and second drying units 51, 52 are 18 m².

The content of the solvent vapor in the exhausted air of the first drying unit 51 is 12 vol. %, and that in the drying air into the second drying unit 52 is the same.

The gel-like film 35 is peeled from the belt 31 with 8N force, when the content of the solvent in the gel-like film 35 is 30 wt. %. Thereafter, the both side edge portion of the gel-like film 35 is held such that the thickness of the film 36 in the tenter apparatus 41 may be 38 μm. As same as the casting equipment 16, the tenter apparatus 41 is provided with first and second drying units 51, 52 for drying in the same condition of temperature of drying and exhausting airs.

Further, in the roller drying apparatus 42, the heat-drying and the cooling are performed. As same as the casting equipment 16, the roller drying apparatus 42 is provided with first and second drying units 51, 52 for drying in the same condition of temperature of drying and exhausted airs. The cooled film is wound by the winding apparatus 47. Then the processing stability in the casting is examined with eyes, and the result thereof is shown in Table 1, in which A means that the processing is stable, and N means that the processing is intermittently not stable. In Example 1, the casting process is stably made, and the film could be adequately produced.

### Example 2

(Preparation of Dope B)

Methylene chloride is used instead of silicon dioxide particle which is used for preparation of the dope B.

(Preparation of Dope C)

The content of the cellulose triacetate is decreased to 17.0 wt. %, and methylene chloride corresponding to the decreased content of the cellulose triacetate is added. Thus the dope C is prepared.

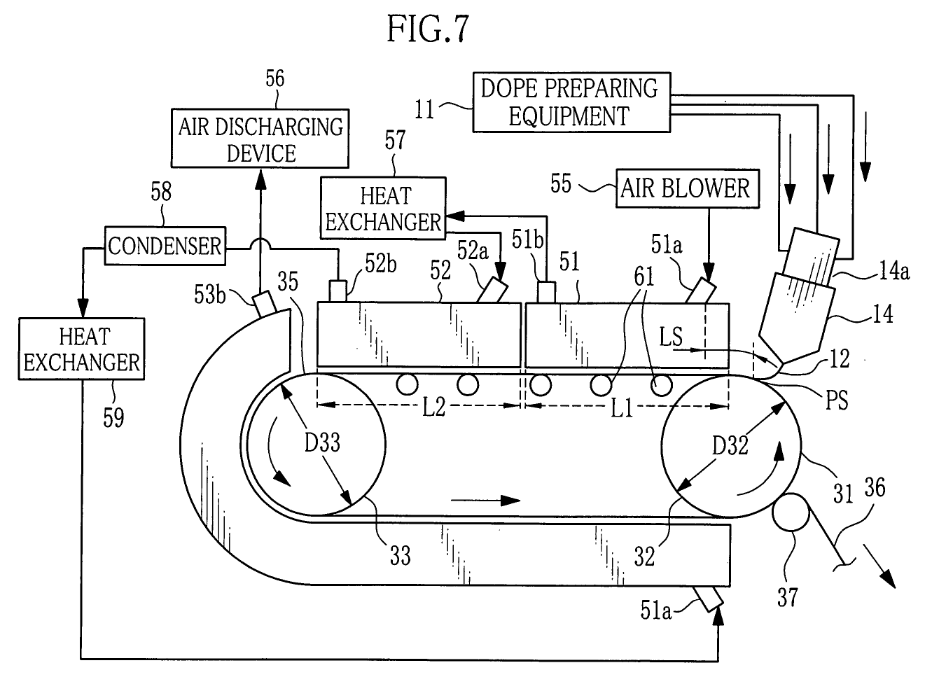

The casting is made with use of the casting equipment as illustrated in FIG. 7. The same parts and members are provided with the same numbers. The casting speed is 40 m/minute, and the casting die 14 is provided with a feed block 14a for performing the co-casting. Further, a third drying unit 53 is disposed downstream from the second drying unit 52 and positioned from above the second drum 33 to below the first drum 32. The dopes B and C are cast onto the belt 31, such that the dope B may form a main layer of 35 μm in thickness in the dried film, and the dope C may form a front surface layer (a surface layer confronting to the drying units) of 2 μm in thickness and a back surface layer (a surface layer contacting to the belt 31) of 3 μm in thickness. In order to prevent the damage of the planarity, there is an aspiration chamber 62 below the casting die 14, and the aspiration is made at 450 kPa. The width of the gel-like film 35 is the same as Example 1.

The confronting area of the gel-like film 35 to the first and second drying units 51, 52, V1/S1, V2/S2 and the angles θ1, θ2 of the drying air to the gel-like film 35 are the same as Example 1. In the first drying unit 51, the temperature of the drying air is 120° C., and that of the exhausted air is 55° C. In the second drying unit 52, the temperature of the drying air is 70° C., and that of the exhausted air is 45° C. The exhausted air from the first drying unit 51 is processed by the heat exchanger 57, and fed as the drying air to the second drying unit 52. In the second drying unit 52, the drying air is supplied from the upstream side, and exhausted from the downstream side. In the third drying unit 53, the confronting area of the gel-like film 35 is 40 m², V3/S3 is 2.7. The content of vapor solvent in the exhausted air from the first drying unit 51 is 11 vol. %, and that from the second drying unit 52 is 12 vol. %. The exhausted air is cooled to −5° C. by a condenser 58, and part of the solvent vapor contained in the exhausted air is recovered. Thereafter, a remaining gas is heated by a heat exchanger 59 and fed to the third drying unit 53. In the third drying unit 53, the supply of the drying air is made in a downstream side, and the drying air has temperature of 60° C. and the content of solvent is 10.5 vol. %. The exhausting is made in the upstream side, and the exhausted air has temperature of 45° C. The total value SA of the confronting areas of the gel-like film to the first-third drying units 51-53 is 76 m².

The gel-like film 35 is peeled as the film 36 from the belt 31 at 12N force. Thereafter, the film 36 is transported to the tenter apparatus 41, in which the film 36 is transported and dried such that the thickness of the film 36 may be 40 μm. Further, in the roller drying apparatus 42, the drying is made at 120N force in the transporting direction while the transporting is made. In the winding equipment 18, the content of the solvent is at most 0.1 wt. %. In Example 2, the casting process is stably made, and the film could be produced adequately.

### Example 3

A dope D is prepared to have the following content. Note that the raw materials of cellulose triacetate is wood pulp and cotton linter whose mixture ratio in mass is 3:7. Further, water content is 0.2% by mass, and a viscosity of 6% in mass of methylene chloride solution is 305 mPa·s. Further, the UV-absorbing agents IV, V, VI are respectively 2,4-bis-(n-octylthio)-6-(4-hydroxy-3,5-di-tert-butylanylino)-1,3,5-triazine, 2(2′-hydroxy-3′,5′-di-tert-butylphenyl)-5-chlorobenzotriazol, and 2(2′-hydroxy-3′,5′-di-tert-amylphenyl)-5-chlorobenzotriazol. Note that water content of each methyl acetate, acetone, methanol, ethanol as the solvent is at most 0.2 wt. %.

| | |
|---|---|
| Cellulose triacetate | 16.00 pts. wt. |
| (degree of acetylation 2.83, viscosity average degree of | |
| polymerization 205, degree of substitution for acetyl | |
| group at 6 position 0.96,) | |
| Triphenylphosphate (TPP) | 0.50 pts. wt. |
| Dipentaerythrithol hexaacetate | 1.50 pts. wt. |
| UV-absorbing agent IV | 0.10 pts. wt. |
| UV-absorbing agent V | 0.10 pts. wt. |
| UV-absorbing agent VI | 0.10 pts. wt. |
| C₁₂H₂₅OCH₂CH₂OP(O)(OK)₂ | 0.05 pts. wt. |
| citric acid ester | 0.02 pts. wt. |
| methylacetate | 56.53 pts. wt. |
| acetone | 10.00 pts. wt. |
| methanol | 5.00 pts. wt. |
| ethanol | 10.00 pts. wt. |

The method of preparing the dope D is as follows. At first, a dissolving tank formed of stainless that has stirrer is cooled to 15° C. Then in the dissolving tank the solvents are mixed, and cellulose triacetate powder are gradually added with stirring the mixture solvent. Thereafter, the mixture is set in the temperature of 30° C. for three hours. Thus the cellulose triacetate in the mixture swells to obtain a dispersion. The dispersion is fed by a screw extrusion machine, and thereby the dispersion flows in a cooling section through −70° C. for 10 minutes. The cooling is made with use of a cooling medium (Florinate, trade name, produced by 3M) which is cooled by a freezing machine. The cooled solution is heated to 50° C. and fed to the tank 21 in FIG. 1. Thereafter, the condition is the same as Example 1.

(Film Producing Method)

The dope D is cast onto to the belt 31 with the same apparatus as in Example 1. The dope D cast on the belt 31 is 1560 mm in width, such that the thickness of the film to be produced may be 35 μm. The casting speed is 32 m/minute. Above the gel-like film are disposed the first drying unit 51 and the second drying unit 52. In the first drying unit 51, the temperature of the drying air is 120° C., and that of the exhausted air is 50° C. Further, in the second drying unit 52, the temperature of the drying air is 90° C., and that of the exhausted air is 45° C. The content of the solvent in the exhausted air from the first drying unit 51 is 10 vol. %. When the content of the solid materials is 30 wt %, the gel-like film 35 is peeled as a film 36 from the belt 31. Thereafter, in the tenter apparatus 41 the both side areas are held such that the film may be 35 μm in thickness. In the first drying unit of the tenter apparatus 41, the temperature of the drying air is 80° C., and that of the exhausted air is 50° C. Further, in the second drying unit of the tenter apparatus 41, the temperature of the drying air is 110° C., and that of the exhausted air is 90° C. Other conditions are the same as in Example 1. In Example 3, the casting process is extremely stably made, and the film could produced adequately.

[Experiment 4]

(Preparation of Dope E)

A dope E is prepared to have the following content. The preparation method is the same as the dope A. Note that the raw materials of cellulose triacetate are wood pulp and cotton linter whose mixture ratio in mass is 3:7. Further, water content is 0.2% by mass, and a viscosity of 6% by mass of methylene chloride solution is 305 mPa·s.

| | |
|---|---|
| Cellulose triacetate | 15.00 pts. wt. |
| (degree of acetylation 2.83, viscosity average degree of | |
| polymerization 205, degree of substitution for acetyl | |
| group at 6 position 0.96,) | |
| Triphenylphosphate (TPP) | 0.50 pts. wt. |
| Dipentaerythrithol hexaacetate | 1.50 pts. wt. |
| citric acid ester | 0.02 pts. wt. |
| silicon dioxide particle | 0.10 pts. wt. |
| (diameter 20 nm) | |
| methylacetate | 57.88 pts. wt. |
| acetone | 10.00 pts. wt. |
| methanol | 5.00 pts. wt. |
| ethanol | 10.00 pts. wt. |

(Preparation of Dope F)

A dope F is prepared to have the same content of the dope D without the silicon dioxide particles. The preparation method is the same as the dope D.

The casting is made with use of the apparatus of a belt method illustrated in FIG. 7. The casting speed is 40 m/minute, and the casting die 14 is provided with the feed block 14a for performing co-casting. A main layer of the gel-like film 35 is formed from the dope F. The thickness of the dried film to be produced may be 35 μm. Further, the dope F is cast to form in the gel-like film 35 an outer surface layer and a contact layer onto the belt 31, such that in the dried film the outer surface layer may be 3 μm in thickness and the contact layer may be 2 μm in thickness. In order to prevent the worse planarity in the casting, a suctioning chamber 62 is provided and the suctioning pressure is adjusted to 450 kPa. The width of the casting is the same as in Example 1.

The confronting areas of the gel-like film 35 to the first and second drying units 51, 52, V1/S1, V2/S2 and the angles θ1, θ2 of the drying air to the gel-like film 35 are the same as Example 2. In the first drying unit 51, the temperature of the drying air is 120° C., and that of the exhausted air is 55° C. In the second drying unit 52, the temperature of the drying air is 70° C., and that of the exhausted air is 45° C. In the third drying unit 53, the confronting area of the gel-like film 35 is 40 m², and V3/S3 is 2.7. The content of vapor solvent in the exhausted air from the first drying unit 51 is 9 vol. %, and that from the second drying unit is 10 vol. %. The exhausted air is cooled to 0° C. by the condenser 58, and part of the solvent vapor contained in the exhausted air is recovered. Thereafter, the remaining gas is heated by the heat exchanger 59 and fed to the third drying unit 53. In the third drying unit 53, the drying air has temperature of 60° C. and the content of solvent is 8 vol. %. The exhausted air has temperature of 45° C. The total value SA (=S1+S2+S3) of the confronting areas of the gel-like film to the first-third drying units 51-53 is 76 m². Other conditions are the same as Example 2.

The gel-like film 35 is peeled as the film 36 from the belt 31 at 12N force. Thereafter, the film 36 is transported to the tenter apparatus 41, in which the film 36 is transported and dried such that the thickness of the film 36 may be 40 μm. Further, in the roller drying apparatus 42, the drying is made at 120N tension in the transporting direction while the transporting is made. In the winding equipment 18, the content of the solvent is at most 0.1 wt. %. In Example 4, the casting process is stably made, and the film could produced adequately.

[Comparison 1]

The respective angles θ1, θ2 of the drying air to the transporting direction in the first and second units 51, 52 are 45°, and other conditions are the same as Experiment 1. In Comparison 1, the wind pressure of the drying wind causes to vibrate a bead. Therefore the bead is unstably formed.

[Comparison 2]

In the first drying unit 51, the temperature of the drying air is 110° C., and that of the exhausted air is 45° C. In the second drying unit 52, the temperature of the drying air is 140° C., and that of the exhausted air is 50° C. Other conditions are the same as Example 1. In Comparison 2, foams are generated in the gel-like film in the casting process.

[Comparison 3]

In the first and second drying units 51, 52, the adjustment is made such that the values V1/S1 and V2/S2 may be 16. Further, in the first drying unit 51 the temperature of the drying air is 90° C. and that of the exhausted air is 60° C. In the second drying unit 52 the temperature of the drying air is 100° C. and that of the exhausted air is 75° C. Other conditions are the same as Example 1.

[Measurement and Judgment of Stability in Casting Process and Thickness of Film]

Stability in the casting process, thickness and appearance of the produced film are judged from appearance thereof. The judgment of the stability and the thickness are made with eyes, and the results thereof are illustrated in Table 1. “A” means the stability in the casting process and “N” means the casting becomes intermittently unstable. As the judgment of appearance of the produced film, “A” means that the unevenness could not observed in the reflection and the transmission, “B” means that the small unevenness is observed, and “N” means that the unevenness is observed.

TABLE 1

| | | CR | Retardation | | | |
|---|---|---|---|---|---|---|
| | SCP | (%) | Re | Rth | FA | PSA |
| Example 1 | A | 2.5 | 2 | 25 | A | A |
| Example 2 | A | 2.2 | 2 | 26 | A | A |
| Example 3 | A | 2.3 | 4 | 30 | A | A |
| Example 4 | A | 1.9 | 4 | 32 | A | A |
| Comparison 1 | N | 4.8 | 5 | 33 | N | B |
| Comparison 2 | N | 4.9 | 6 | 34 | N | B |
| Comparison 3 | N | 5.3 | 5 | 34 | N | B |

SCP: Stability of Casting Process
CR: Changing Ratio of Film Thickness
FA: Film Appearance
PSA: Polarizing filter Appearance

[Measurement of Retardation Value and Transmittance]

The retardation value and the transmittance of each film produced in Examples 1-4 and comparisons 1-3 are obtained in the methods of measuring birefringence and transmittance. The the retardation values Re and Rth are measured at the same position as in the measurement of the thickness. The result of the measurement is shown in Table 1.

The retardation value Re is calculated from a value of extrapolation of measured retardation value which is measured in a perpendicular direction to the film surface by radiating the 632.8 nm light. Thereby the measurement is made with an automatic birefringence meter (KOBRA21DII, produced by Oji Scientific Instrument). Further, the irradiation of the 632.8 nm light to the film is made. At first, the light is irradiated perpendicularly to the film to obtain the retardation value Re, then the film surface was gradually inclined to the irradiated film and thereby the retardation values Re are obtained. The retardation value Rth is calculated from values of extrapolation of the measured retardation values Re. Thereby the measurement is made with an automatic birefringence meter (Ellipsometer M150, produced by Jusco Corporation).

[Production of Polarizing Filter]

Iodine is adsorbed to the oriented polyvinylalcohol film to produce a polarized film. Then the films produced in each Examples 1-4 and Comparisons 1-3 are adhered to both sides of the polarized film with an adhesive agent of polyvinylalcohol type such that a slow axis of the film and the transmission axis of the polarized film may be parallel. This sample of the polarizing filter was set in the atmosphere at 80° C. and the humidity of 90% RH for 500 hours. The judgment of the appearance of the sample is made with eyes, and the result thereof is shown in Table 1. Note that “A” means that the change of the color strength in the cross-nicol position is not observed, “B” means that the small change of the color strength is observed, and “N” means that the change of the color strength is apparently observed.

[Estimation of Polarization Degree]

The parallel transparency Yp and the orthogonal transparency Yc of the polarized light in a visible area are measured with a spectrophotometer. Thereafter, a polarization degree was calculated from the following formula, based on the parallel transparency Yp and the direct transparency Yc:

P=[(Yp−Yc)/(Yp+Yc)]^{1/2}×100(%)

In the polarizing filter in which the film produced in each Example 1-4 is used, the polarization degree was more than 99.6%. The polarizing filter had the enough endurance. However, in the polarizing filter in which the film produced in each Comparison 1-3 is used, the polarization degree was more than 99.4%-99.6%.

[Production of Optical Compensation Film]

Iodine is adsorbed to the drawn polyvinylalcohol film to produce a polarized film. Then the film produced in Example 1 is adhered to a surface of the polarized film with an adhesive agent of polyvinylalcohol type such that a slow axis of the film and the transmission axis of the polarized film may be parallel. Further, the saponification of the another film obtained in Example 1 is made, and thereafter the saponificated film is adhered to another surface of the polarized film with an adhesive agent of polyvinylalcohol type. Further, an optical compensation sheet (WV film produced by Fuji Photo Film Co. Ltd) is adhered to the former film (or non-saponificated film) such that a slow axis of this film and that of the optical compensation sheet may be parallel. Thus the optical compensation film is obtained. Further, the optical compensation film is produced with use of the films in each Example 2-4 and comparison 1-3.

A pair of the optical compensation films obtained from the films of respective Examples 1-4 and Comparisons 1-3 are used in a liquid crystal display of TFT (thin film transistor) type. When the films of Examples 1-4 are used, the view angle and the contrast are adequate. Otherwise, when the film of Comparisons 1-3 are used, the contrast becomes lower.

[Producing Antireflection Film]

An antireflection film provided with an antiglare layer is produced in the following process by using the films in Example 1 and comparison 1.

(Preparation of Coating Solution F for Antiglare Layer)

In order to prepare a coating solution F for an antiglare layer, a mixture (DPHA, produced by NIPPON KAYAKU CO., LTD.) is used, in which dipentaerythritol pentaacrylate and dipentaerythritol hexaacrylate are mixed. The mixture of 125 g and bis(4-metacryloil thiophenyl)sulfide (MPSMA, produced by SUMITOMO SEIKA CHEMICALS CO., LTD.) of 125 g are dissolved in a mixture solvent of 439 g that contained methylethylketone of 50 wt. % and cyclohexanone of 50 wt. %. Thus a first solution is obtained. Further, second solution is prepared. In the second solution, a photoinitiator for radical polymerization (IRGACURE 907, produced by Chiba Gaigy Japan Limited) of 5.0 g and photosensitizer (KAYACURE DETX, produced by NIPPON KAYAKU CO., LTD.) of 3.0 g are dissolved in methylethyl ketone of 49 g. The second solution is added to the first solution to obtain an added solution. The added solution is coated and thereafter cured with ultraviolet ray to obtain a coating layer, which had refractive index of 1.60.

Further, crosslinked polystyrene particles (name of product: SX-200H, produced by Soken Chemical & Engineering Co., Ltd.) of 10 g, whose average particle diameter is 2 μm, are added to the added solution, and this mixture is stirred to disperse the crosslinked polystyrene particles with a high speed stirrer for an hour. The stir speed thereof is 5000 rpm. Thereafter, the filtration of the dispersed solution is made with a polypropylene filter having pores whose diameter each is 30 μm. Then the coating solution F for antiglare layer is obtained.

(Preparation of Coating Solution G for Antiglare Layer)

A mixture solvent containing cyclohexanone of 104.1 g and methylethyl ketone 61.3 g is stirred with an air stirrer. Thereby a coating solution for hard coat (DeSolite KZ-7886A, produced by JSR corporation) of 217.0 g that contained zirconium oxide is added to the mixture solvent to obtain an added solution. The added solution is cast and thereafter cured with ultraviolet ray to obtain a coating, which had refractive index of 1.61. Further, crosslinked polystyrene particles (name of product: SX-200H, produced by Soken Chemical & Engineering Co., Ltd.) of 5 g, whose average particle diameter is 2 μm, are added to the added solution, and this mixture is stirred to disperse the crosslinked polystyrene particles with a high speed stirrer for an hour. The stir speed thereof is 5000 rpm. Thereafter, the filtration of the dispersed solution is made with a polypropylene filter having pores whose diameter each is 30 μm. Then the coating solution G for antiglare layer is obtained.

(Preparation of Coating Solution H for Antiglare Layer)

In order to prepare a coating solution H for an antiglare layer, Methylethyl ketone and cyclohexanone are mixed in ratio of 54 wt. % and 46 wt. % for using as the solvent. Further, a mixture (DPHA, produced by NIPPON KAYAKU CO., LTD.) is used, in which dipentaerythritol pentaacrylate and dipentaerythritol hexaacrylate are mixed. The solvent of 52 g is supplied with 91 g of the mixture, 199 g of hard coat solution containing zirconium oxide (DeSolite KZ-7115, produced by JSR corporation), and 19 g of hard coat solution containing zirconium oxide dispersion (DeSolite KZ-7161, produced by JSR corporation). Thus the mixture is dissolved to obtain a mixed solution. Then in the mixed solution is dissolved a photoinitiator for radical polymerization composition (IRGACURE 907, produced by Chiba Gaigy Japan Limited) of 10 g to obtain an added solution. The added solution is coated and thereafter cured with ultraviolet ray to obtain a coating, which had refractive index of 1.61.

Further, crosslinked polystyrene particles (name of product: SX-200H, produced by Soken Chemical & Engineering Co., Ltd.) of 20 g, whose average particle diameter is 2 μm, are added to a mixture solvent of 80 g, in which methylethylketone of 54 wt. % and cyclohexanone of 46 wt. % are mixed. This solution is stirred to disperse the crosslinked polystyrene particles with high speed stirrer of 5000 rpm for an hour, and added to the added solution to obtain the dispersed solution. Thereafter, the filtration of the dispersed solution is made with a polypropylene filter having pores whose diameter each is 30 μm. Then the coating solution H for antiglare layer is obtained.

(Preparation of Coating Solution I for Hard Coating)

In order to prepare a coating solution I for a hard coating, Methylethylketone of 62 g and cyclohexanone of 88 g are mixed for using as the solvent. Then, UV-ray curable hard coat composition (DeSolite KZ-7689, 72 wt. %, produced by JSR corporation) of 250 g is dissolved to the solvent. This obtained solution is coated and cured in ultraviolet ray to form a coating layer, which had refractive index of 1.53. Further, the solution is filtrated with a polypropylene filter having pores whose diameter each is 30 μm. Then the coating solution I for hard coating layer is obtained.

(Preparation of Coating Solution J for Low Refractive Index Layer)

MEK-ST of 8 g (average diameter of particles is 10 nm-20 nm, SiO₂ sol dispersion of methylethylketone, whose solids content degree is 30 wt. %, produced by Nissan Chemical Industries Co., Ltd.) and methylethylketone of 100 g are added to heat closslinked polymer (TN-049, produced by JSR Corporation) of 20093 g containing fluoride that had refractive index of 1.42. This mixture is stirred and filtrated with a polypropylene filter having pores whose diameter is 1 μm. Thus the coating solution J for low refractive index layer is obtained.

A surface of the film of each Example 1 and Comparison 1 is coated with the coating solution I by using a bar coater, and thereafter dried at 120° C. Then an UV light is applied to the coating layer on the film with air-cooled type metal halide lamp of 160 W/cm (produced by Eyegraphics Co., Ltd.). The illuminance is thereby 400 mW/cm², and illumination density is 300 mJ/cm². Thus the coating of the dope is cured to form the hard coat layer of thickness of 2.5 μm on the film. Further, the coating solution F is applied on the hard coat layer on the film with the bar coater. The coating solution F is dried and cured in the same conditions as in forming the hard coat layer. Thus the antiglare layer A of 1.5 μm is formed. Furthermore, the antiglare layer A is coated with the coating solution J for the low refractive index layer, and thereafter the coating solution J is dried at 80° C. Then the cross-linking of the film is made at 120° C. for ten minutes to form a low refractive index layer whose thickness is 0.096 μm.

The coating solution G is used for coating the film instead of the coating solution F. Other conditions are the same to form the antireflection film. In this case, an antiglare layer B is formed. Furthermore, the coating solution H is used for coating the film instead of the coating solution F. Other conditions are the same to form the antireflection film. In this case, an antiglare layer C is formed.

(Estimation of Antireflection Film)

The following examinations are made for the estimation of the respective antireflection films having the antiglare layers A, B, C. The results of the examination is shown in Table 2.

(1) Specular Reflectance and Color Tint

A spectrophotometer V-550 (produced by JASCO Corporation) is provided with an adapter ARV-474 to measure the specular reflectance at an exiting angle of −5° according to the incident light of wavelength from 380 nm to 780 nm at the incident angle of 50. Then the average of the specular reflectance of the reflection whose wavelength is from 450 nm to 650 nm is calculated to evaluate properties of antireflection.

A reflection spectrum is obtained from a data of the observation. Then from the reflection spectrum are calculated L* number, a* number and b* number in a CIE 1976 L*a*b* space, which represent the color tint of the regular reflection to a light generated with an incident angle at 5° by a CIE standard light source D65. The color tint is estimated on the basis of the L* number, a* number and b* number.

(2) Integral Reflectance

Further, a spectrophotometer V-550 (produced by JASCO Corporation) is provided with an adapter ILV-471 to measure the integral reflectance according to the incident light of wavelength between 380 nm and 780 nm at the incident angle of 5°. Then the average of the integral reflectance of the reflection whose wavelength is between 450 nm and 650 nm is calculated to evaluate antireflection properties.

(3) Haze

A haze meter MODEL 1001 DP, (produced by Nippon Denshoku Industries Co., Ltd.) is used for measurement of haze of the antireflection film.

(4) Pencil Hardness

The evaluations of pencil hardness is made as described in JIS K 5400 and the data thereof is used as a criterion of scratch resistance. After the antireflection film is set in atmosphere with the temperature of 25° C. and the humidity of 60% RH for two hours, the surface of the antireflection film is scratched with a 3H test pencil determined in JIS S 6006. Thereby a force of 1 kg is applied to the test pencil. The evaluation of the pencil hardness is “A”, when no scratch remains on the surface in evaluation of n=5 (n is number of performances of scratching). The evaluation is “B”, when one or two scratches remained on the surface in evaluation of n=5. The evaluation is “N” when more than three scratches remain on the surface in evaluation of n=5.

(5) Contact Angle

After the antireflection film is set in the atmosphere at 25° C. and the humidity of 60% RH for two hours, the contact angle to the water on the antireflection film is measured, and the data thereof is used as a criterion of antistaining, especially finger printing stain proofness.

(6) Coefficient of Dynamic Friction

After the antireflection film is set in the atmosphere with the temperature of 25° C. and the relative humidity of 60% for two hours, the coefficient of dynamic friction is measured with a machine for measuring the coefficient of dynamic friction, HEIDON-14, in which a stainless steel ball of ¢5 mm is used. Thereby, the speed is set to 60 cm/min, and a force of 1.00×10³ mN is applied on the surface of the antireflection film.

(7) Antiglare Property

A fluorescent lamp (8000 cd/m²) without louver emitted a light onto the antireflection film and the light reflects. An image of the fluorescent lamp formed by the reflection is observed. The estimation of antiglare property is “E” (Excellent) when no outline of the illumination lamp is observed. The estimation is “G” (Good) when the outline is slightly recognized. The estimation is “P” (Pass) when the outline is not clear but recognized. The estimation is “R” (Reject) when the outline is almost clear.

TABLE 2

| Kind | | | | | | | | | |
|---|---|---|---|---|---|---|---|---|---|
| of | | SR | IR | Color Tint | H | PH | | | |
| Dope | SA | (%) | (%) | L*/a*/b | (%) | (3H) | CA | DF | AP |
| Ex. 1 | A | 1.1 | 2.0 | 10/1.9/1.3 | 8 | A | 103° | 0.08 | E |
| | B | 1.1 | 2.0 | 9/2.0/−4.0 | 9 | A | 103° | 0.08 | E |
| | C | 1.1 | 2.0 | 9/1.7/0.2 | 10 | A | 103° | 0.08 | E |
| Co. 2 | A | 1.2 | 2.1 | 10/2.0/1.4 | 7 | B | 103° | 0.09 | R |
| | B | 1.3 | 2.2 | 9/2.0/−3.0 | 8 | B | 103° | 0.08 | R |
| | C | 1.2 | 2.4 | 10/1.5/0.4 | 11 | B | 103° | 0.08 | R |

SA: Kind of solution for antiglare layer
SR: Specular Reflectance
IR: Integral Reflectance
H: Haze
PH: Pencil Hardness
CA: Contact Angle
DF: Coefficient of Dynamic Friction
AP: Antiglare Property

Table 2 teaches that the antireflection film produced in Example 1 is excellent in the antiglare property and the antireflection property. Further, the color tint is low, and the evaluations of pencil hardness, the contact angle or the finger printing stain proofness, and the coefficient of dynamic friction are excellent. Further, mura including thickness-nonuniformity and the uneven coating is observed in the antireflection film produced in Comparison 1.

Various changes and modifications are possible in the present invention and may be understood to be within the present invention.

What is claimed is:

1. A method of producing a film from a polymer solution in which polymers are dissolved to a solvent, said polymer solution being cast on a moving substrate to form a gel-like film, said gel-like film being peeled as said film from said substrate, said method comprising steps of:
drying said gel-like film with plural drying units which are arranged in moving direction of said substrate so as to be near said gel-like film, said drying unit blowing a drying air toward said gel-like film and aspirating an air containing a vapor to which said solvent evaporates from said gel-like film, so as to exhaust said air as an exhausted air; and
performing a control such that a temperature difference between said drying air and said exhausted air in a upstream drying unit of said plural drying units may be larger than in a downstream drying unit.

2. A method claimed in claim 1, wherein a control is made such that a temperature of said drying air of said downstream drying unit may be higher than a temperature of said exhausted air of said upstream drying unit.

3. A method claimed in claim 2, wherein said exhausted air of said upstream drying unit is used as said drying air of said downstream drying unit.

4. A method claimed in claim 3, wherein a temperature adjusting device makes an adjustment for raising the temperature of said exhausted air of said upstream drying unit before said exhausted air of said upstream drying unit is supplied as said drying air for said downstream drying unit.

5. A method claimed in claim 1, wherein a concentration of a solvent vapor contained in said exhausted air of said upstream drying unit is decreased with a solvent recovering device.

6. A method claimed in claim 1, wherein when an area in which said gel-like film confronts to said each drying unit is SN (m²) and a volume of said drying air supplied per one minute is VN (m³/minute), a following condition is satisfied:
0.1<VN/SN<15.

7. A method claimed in claim 6, wherein a total value SA as a sum of said respective areas SN of said drying units is in the range of 20 m² to 200 m².

8. A method claimed in claim 1, wherein a quantity of said solvent evaporated by said upstream drying unit is larger than by said downstream drying unit.

9. A method claimed in claim 8,
wherein a inlet port of said drying air into said upstream drying unit is at least 50 cm apart from a casting position at which said polymer solution contacts to said substrate by the casting, and
wherein said drying air of said upstream drying unit is blown toward said gel-like film in the same direction as a transporting direction of said gel-like film with an angle of at most 10° to said gel-like film.

10. A method claimed in claim 1, wherein a confronting area of said substrate to one of said plural drying units is from 4 m² to 80 m².

11. A method claimed in claim 1, wherein a temperature difference between said drying air and said exhausted air in one of said plural drying units is from 10° C. to 100° C.

12. A method claimed in claim 11, wherein said drying air of said downstream drying unit is blown toward said gel-like film in an opposite direction to a transporting direction of said gel-like film with an angle of at most 10° to said gel-like film.

13. A method claimed in claim 1,
wherein said substrate is a stainless belt wrappings a pair of drums,
wherein said belt has a width of lm-3 m, a length of 25 m-100 m, and an arithmetical averaged surface roughness Ra of at most 0.1 μm,
wherein said drum has a width of 1.5 m-3 m, and
wherein a tension in said moving direction of said moving belt is from 1.0×10⁵ N/m to 1.0×10⁶ N/m.

14. A method claimed in claim 13, wherein a temperature of said drying air in at least one drying unit is at least −30° C. and less than 10° C.

15. A method claimed in claim 1, wherein said film is further dried by a tenter apparatus with a dryer and a roller drying apparatus with a dryer.

16. A method claimed in claim 1, wherein said polymer contains cellulose acylate.

17. A method claimed in claim 1, wherein said produced film is an optical polymer film.

18. A method claimed in claim 17, wherein said optical polymer film is used as a protective film for a polarizing filter.

19. A method claimed in claim 17, wherein said optical polymer film is used in a polarizing filter.

20. A method claimed in claim 17, wherein said optical polymer film is used in an optical functional film.

21. A method claimed in claim 17, wherein said optical polymer film is used in a liquid crystal display.

22. A method for producing a film by casting a polymer solution, comprising steps of:
drying said film with plural drying units which are arranged near said film in a transporting direction of said film, said drying unit blowing a drying air toward said film and aspirating an air containing a vapor to which said solvent is evaporated from said film, so as to exhaust said air as an exhausted air; and
maintaining a temperature difference between said drying air and said exhausted air in a upstream drying unit of said plural drying units larger than in a downstream drying unit.

23. A method as claimed in claim 22, further comprising steps of:
casting said polymer solution on said substrate to form said film; and
peeling said film from said substrate.

24. A method as claimed in claim 23, wherein said plural drying units dry said film on said substrate.

25. A method as claimed in claim 23, further comprising a tenter step of drawing said film in one direction in one tenter apparatus, and a step of drying with a roller drying apparatus, said plural drying units being provided for said tenter apparatus or said roller drying apparatus.
